(19) United States
(12) Patent Application Publication
(10) Pub. No.: US 2025/0356136 A1
(43) Pub. Date: Nov. 20, 2025

(54) RECORDING MEDIUM, GENERATION METHOD, AND INFORMATION PROCESSING DEVICE

(71) Applicant: Fujitsu Limited, Kawasaki-shi (JP)

(72) Inventors: Junki OURA, Kawasaki (JP); Tatsuya KIKUZUKI, Kawasaki (JP); Akihiro WADA, Kawasaki (JP); Kaoru YOKOO, Yokosuka (JP); Masatoshi OGAWA, Zama (JP); Teruhisa NINOMIYA, Yokohama (JP); Jun KAKUTA, Yokohama (JP)

(73) Assignee: Fujitsu Limited, Kawasaki-shi (JP)

(21) Appl. No.: 19/200,863

(22) Filed: May 7, 2025

(30) Foreign Application Priority Data
May 15, 2024 (JP) 2024-079791

(51) Int. Cl. G06F 40/40; G06F 16/3329; G06F 40/253

(52) U.S. Cl. CPC G06F 40/40; G06F 16/33295; G06F 40/253

(57) ABSTRACT

A computer-readable recording medium stores therein a generation program for causing a computer to execute a process including: retrieving a first sentence data related to a first question sentence by referring to a storage unit that stores a plurality of sentence data; and generating a second question sentence in which a style of the first question sentence is modified so as to maintain a meaning of the first question sentence, the second question sentence being generated based on the retrieved first sentence data, using a first language model for generating a sentence.

### CROSS REFERENCE TO RELATED APPLICATIONS

This application is based upon and claims the benefit of priority of the prior Japanese Patent Application No. 2024-079791, filed on May 15, 2024, the entire contents of which are incorporated herein by reference.

### FIELD OF THE INVENTION

Embodiments discussed herein relate to a recording medium, a generation method, and an information processing device.

### BACKGROUND OF THE INVENTION

Conventionally, there is a retrieval-augmented generation (RAG) system that combines a generation model of artificial intelligence (AI) in a natural language processing field with an information retrieval-based approach. In the RAG system, for example, a question and answer (QA) related to a question sentence is retrieved from a database to generate an answer from the retrieved QA and the question sentence.

As a prior art, there is a question-and-answer display system that converts a question sentence input from an administrator terminal into one or more question sentences of different expressions corresponding to the same answer pattern as the input question sentence, the input question sentence being converted based on a question-and-answer database containing an answer pattern and multiple question patterns corresponding to the answer pattern. There is an art for generating at least one query data that can be answered by a document using a language model for a provided document and for using data to learn a retrieval model for a dialogue bot, the data consisting of documents that belong to a specific domain and that are respectively paired with the query data generated therefor.

There is also an art for generating multiple modified questions by rephrasing a user's question, selecting answer candidates corresponding to the user's question and the modified question respectively, thereby detecting at least one of the selected answer candidates as an answer. There is also an art for generating a prompt by generating additional sentences related to the question sentence, based on an input question sentence; a total number of characters including the number of characters of the question sentence not exceeding a limit on the number of characters that can be input to a large-scale language model. For examples, refer to Japanese Laid-Open Patent Publication No. 2021-108033, Japanese Laid-Open Patent Publication No. 2023-76413, U.S. Patent Application Publication No. 2016/0140958, and Japanese Patent No. 7313757.

### SUMMARY OF THE INVENTION

According to an aspect of an embodiment, a computer-readable, recording medium stores therein a generation program for causing a computer to execute a process including: retrieving a first sentence data related to a first question sentence by referring to a storage unit that stores a plurality of sentence data; and generating a second question sentence in which a style of the first question sentence is modified so as to maintain a meaning of the first question sentence, the second question sentence being generated based on the retrieved first sentence data, using a first language model for generating a sentence.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of a generation method according to a first embodiment.

FIG. 2 is an explanatory diagram depicting an example of a system configuration of an answer generating system 200.

FIG. 3 is a block diagram depicting an example of a hardware configuration of an answer generating device 201.

FIG. 4 is an explanatory diagram depicting an example of storage contents of a sentence database 220.

FIG. 5 is a block diagram depicting an example of a functional configuration of the answer generating device 201 according to the first embodiment.

FIG. 6 is an explanatory diagram depicting an example of operation of the answer generating device 201 according to the first embodiment.

FIG. 7 is an explanatory diagram depicting an example of a user's question sentence.

FIG. 8 is an explanatory diagram depicting a specific example of a proofreading prompt.

FIG. 9 is an explanatory diagram depicting an example of a question sentence after a primary modification.

FIG. 10 is an explanatory diagram depicting a specific example of a style-changing prompt.

FIG. 11 is an explanatory diagram depicting an example of a question sentence after a secondary modification.

FIG. 12 is a flowchart depicting an example of a DB registration process procedure of the answer generating device 201 according to the first embodiment.

FIG. 13 is a flowchart depicting an example of an answer generation process procedure of the answer generating device 201 according to the first embodiment.

FIG. 14 is an explanatory diagram depicting an example of contents stored in a sentence feature table 1400.

FIG. 15 is a block diagram depicting an example of the functional configuration of the answer generating device 201 according to a second embodiment.

FIG. 16 is an explanatory diagram depicting a specific example of a prompt for modifying styles.

FIG. 17 is an explanatory diagram depicting an example of the operation of the answer generating device 201 according to the second embodiment.

FIG. 18 is a flowchart depicting an example of a table creation processing procedure of the answer generating device 201 according to the second embodiment.

FIG. 19 is a flowchart depicting an example of an answer generation processing procedure of the answer generating device 201 according to the second embodiment.

### DESCRIPTION OF THE INVENTION

First, problems associated with the conventional techniques are discussed. In the conventional techniques, in generating an answer to a question sentence, there is a problem in that the retrieval accuracy of information related to the question (e.g., QA) decreases. For example, when the retrieval accuracy of information related to the question sentence decreases, ultimately the accuracy of generating an answer to the question sentence decreases.

Embodiments of a recording medium, a generation method, and an information processing device according to the present invention are described in detail with reference to the accompanying drawings.

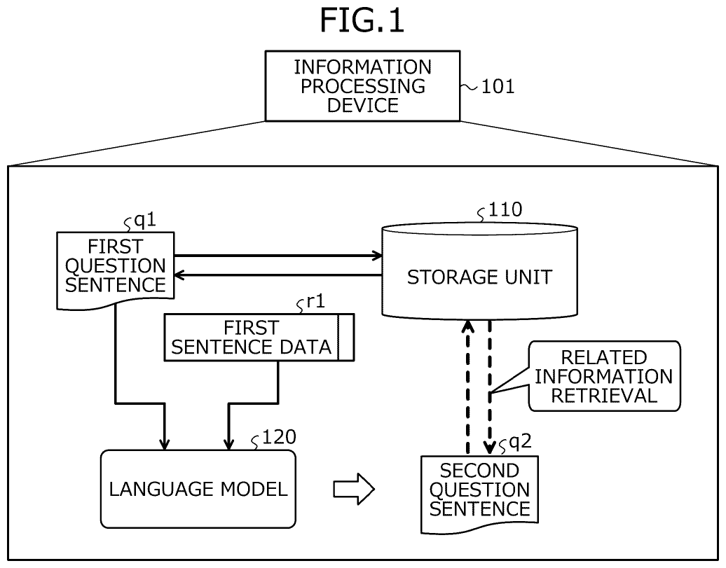

FIG. 1 is an explanatory diagram depicting an example of a generation method according to a first embodiment. In FIG. 1, an information processing device 101 is a computer that generates a new question sentence (second question sentence) by modifying a writing style of a question sentence (first question sentence). The question sentence is information (text data) showing contents of a question.

Here, a RAG system is an art combining an AI generation model in a natural language processing field and an information retrieval-based approach. An example of the AI generation model in the natural language processing field is large language models (LLM).

The LLM is a language model constructed by conducting learning by deep learning using a large amount of text data. Language models such as the LLM tend to learn a large amount of general knowledge and thus, a problem arises in that specialization in technical knowledge in a specific task is difficult, while natural sentences like those used by people can be generated easily.

On the other hand, the information retrieval-based approach has a problem of having difficulty in guaranteeing the consistency and naturalness of the answers, regardless of its characteristic of retrieving information from a large document group in order to find an answer to a specific question. The RAG system aims to generate more efficient and natural responses by combining these approaches.

In a conventional RAG system, for example, in a case that a question-and-answer session (QA) specialized in a certain field (such as a company or public service) is handled, the process is performed according to the following flow.

First, in the conventional RAG system, past QA lists are converted into sentence vectors in advance and are stored to a database. In the conventional RAG system, in response to a question sentence from a user, the question sentence is converted into the sentence vector and a distance thereof to the sentence vector in the database is calculated, and a sentence whose distance is small is retrieved as a related QA. The conventional RAG system then generates an answer using the LLM, based on the retrieved related QA and the question sentence.

However, a QA list specialized in a certain field may use an expression specific to that field or may use a large number of technical terms. In such cases, the conventional RAG system has a problem in that a vector-to-vector distance to the sentence to be retrieved increases depending on the way question sentences are written and the presence or absence of technical terms, resulting in reduced retrieval accuracy for the related QA.

For example, in a QA list specialized in a certain field, regarding objects A and B, the features of objects A and B are often described together in a sentence expression such as “objects A and B are blue”. In contrast, in a user's question sentence, the objects A and B may be described separately such as “Is object A blue?” and “Is object B blue?”.

In this case, in the conventional RAG system, a vector-to-vector distance between the question sentence and a related QA sentence increases, resulting in decreased retrieval accuracy of the related QA. For example, compared with the vector distance between the question sentences “Are objects A and B blue?” and “Objects A and B are blue”, the vector distance between the question sentences “Is object A blue?” and “Is object B blue?” and “Objects A and B are blue” becomes large, resulting in decreased retrieval accuracy of the related QA. Decreased retrieval accuracy of the related QA results in decreased accuracy in generating an answer to the question sentence.

In the present embodiment, in generating an answer to a question sentence, a generating method that improves the retrieval accuracy of information related to the question sentence is described. Here, processing examples (corresponds the following processes (1) to (3)) by the information processing device 101 are described.

(1) The information processing device 101 receives a first question sentence. The first question sentence is input, for example, by a user.

In the example depicted in FIG. 1, a case is assumed in which a first question q1 is input.

(2) The information processing device 101 refers to a storage unit 110 that stores multiple sentence data and retrieves a first sentence data related to the first question sentence q1. Here, the sentence data is information related to sentences. The sentences may be accumulated as knowledge such as past Q&A (Q&A) or may be extracted from a textbook, a manual, etc.

For example, the sentence data may be information (text data) representing sentences. The sentence data may be information representing a sentence and a feature amount of the sentence. The feature amount of a sentence is information representing the feature of the sentence, for example, a sentence vector.

For example, the information processing device 101 may refer to the storage unit 110 and retrieve a first sentence data representing a sentence having features similar to the first question sentence q1 by comparing the feature amount of a sentence represented by sentence data included in multiple sentence data with the feature amount of the first question sentence q1.

In the example depicted in FIG. 1, a case is assumed in which the first sentence data r1 is retrieved. The first sentence data r1 represents a sentence having similar features to the first question sentence q1.

(3) The information processing device 101 generates a second question sentence q2 in which a writing style of the first question sentence q1 is changed so that the meaning thereof is the same as that of the first question sentence q1, the information processing device 101 uses a language model 120 according to the retrieved first sentence data to generate the second question sentence q2. The language model 120 here is a language model (learning model) for generating sentences, for example, the LLM.

A writing style (style) is a feature of sentence expression and appears in, for example, the words, idioms, and rhetoric used in sentences. For example, the information processing device 101 creates a prompt (command sentence) that instructs rewriting of the first question sentence q1 using as many of the styles (words, idioms, rhetoric, and the like) used in the sentence represented by the first sentence data r1 as possible so as not to change the meaning. Then, the information processing device 101 generates the second question sentence q2 by providing the created prompt to the language model 120.

As described, according to the information processing device 101, in generating the answer to the question sentence (for example, the first question sentence q1), the retrieval accuracy of information related to the question sentence can be improved.

For example, sentence data (including the first sentence data r1) representing sentences specialized in a certain field (such as a company or public service) is assumed to be stored in the storage unit 110. The second question sentence q2, for example, corresponds to a rewriting of the first question sentence q1 using technical terms and expressions that appear in the sentence represented by the first sentence data r1.

Therefore, the second question q2 can be said to be similar in style to the sentence (the sentence specialized in a certain field) represented by the sentence data stored in the storage unit 110, as compared to the first question sentence q1. The information processing device 101 can generate a question sentence that is more likely to hit appropriate information by making the style of the question sentence similar to the sentence to be searched for.

Then, when generating an answer to the first question sentence q1, the information processing device 101 can retrieve more appropriate information (such as related Q&A) by using the generated second question q2 to retrieve related information, resulting in improving the accuracy of generating the answer.

Next, a system configuration example of an answer generating system 200 including the information processing device 101 depicted in FIG. 1 is described. Here, a case where the information processing device 101 depicted in FIG. 1 is applied to an answer generating device 201 in the answer generating system 200 is described as an example. The answer generating system 200 can be applied to, for example, the RAG system.

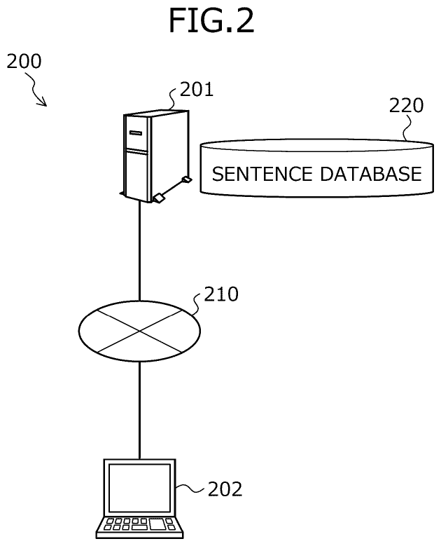

FIG. 2 is an explanatory diagram depicting an example of a system configuration of the answer generating system 200. In FIG. 2, the answer generating system 200 includes the answer generating device 201 and a client device 202. In the answer generating system 200, the answer generating device 201 and the client device 202 are connected via a wired or wireless network 210. The network 210 is, for example, the Internet, a LAN (Local Area Network), or a WAN (Wide Area Network).

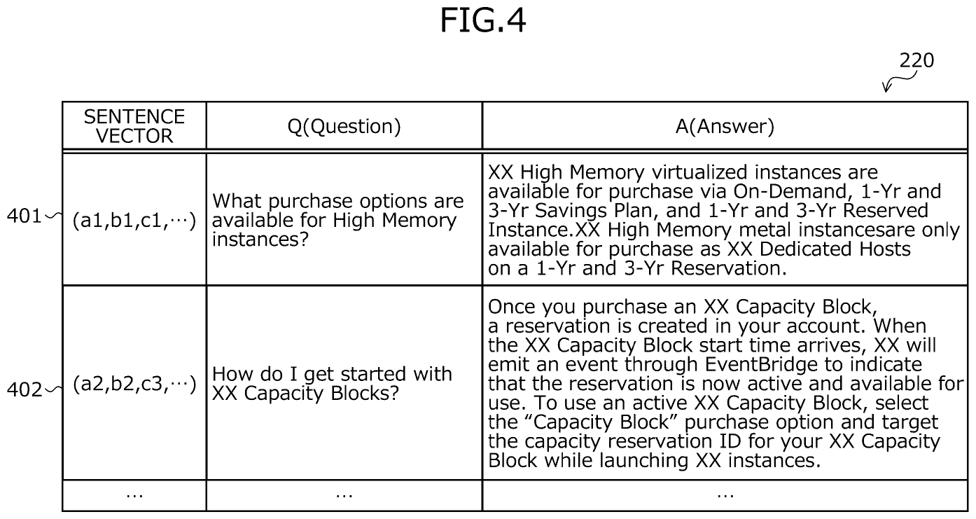

Here, the answer generating device 201 is a computer with a sentence database 220 and outputs the answer to the question sentence. The answer generating device 201 is, for example, a server. The sentence database 220 stores multiple sentence data. The stored contents of the sentence database 220 is described later with reference to FIG. 4.

The client device 202 is a computer used by a user of the answer generating system 200. The user is, for example, a person asking a question. The client device 202 is, for example, a personal computer (PC), a tablet PC, a smartphone, or the like.

Here, while the answer generating device 201 and the client device 202 are provided separately, configuration is not limited hereto. For example, the answer generating device 201 may be implemented by the client device 202. The answer generating system 200 may include multiple client devices 202.

An example of a hardware configuration of the answer generating device 201 is described.

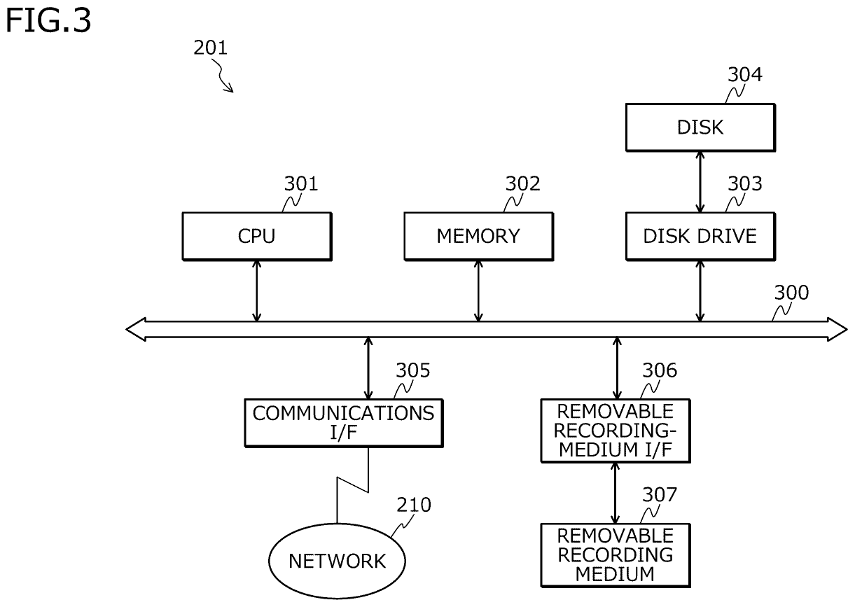

FIG. 3 is a block diagram depicting an example of a hardware configuration of the answer generating device 201. In FIG. 3, the answer generating device 201 has a central processing unit (CPU) 301, a memory 302, a disk drive 303, a disk 304, a communications interface (I/F) 305, A removable recording-medium I/F 306, and a removable recording medium 307. Further, the components are connected to each other by a bus 300.

Here, the CPU 301 governs overall control of the answer generating device 201. The CPU 301 may have multiple cores. The memory 302, for example, includes a read-only memory (ROM), a random-access memory (RAM), and the like. Programs stored in the memory 302 are loaded onto the CPU 301, whereby encoded processes are executed by the CPU 301.

The disk drive 303, under the control of the CPU 301, controls the reading and writing of data with respect to the disk 304. The disk 304 stores data written thereto under the control of the disk drive 303. The disk 304 is, for example, a magnetic disk, an optical disk, etc.

The communications I/F 305 is connected to the network 210 through a communications line and is connected to external computers (for example, the client device 202 depicted in FIG. 2) via the network 210. Further, the communications I/F 305 administers an internal interface with the network 210 and controls the input and output data from external computers. The communications I/F 305 is, for example, a modem, a LAN adapter, etc.

The removable recording-medium I/F 306, under the control of the CPU 301, controls the reading and writing of data with respect to the removable recording medium 307. The removable recording medium 307 stores data written thereto under the control of the removable recording-medium I/F 306. The removable recording medium 307 is, for example, a compact disc read-only memory CD-ROM, a digital versatile disk (DVD), a universal serial bus (USB) memory, etc.

In addition to the components above, the answer generating device 201 may have, for example, an input device, a display, etc. Further, the answer generating device 201 may omit, for example, the removable recording-medium I/F 306 and the removable recording medium 307. Further, the client device 202 depicted in FIG. 2 may also be implemented by a hardware configuration similar to that of the answer generating device 201. However, the client device 202 has, for example, an input device, display, etc. in addition to the components above.

Next, the storage contents of the sentence database 220 of the answer generating device 201 according to the first embodiment is described using FIG. 4. The sentence database 220 is implemented by, for example, a storage device such as the memory 302 and the disk 304 depicted in FIG. 3.

FIG. 4 is an explanatory diagram depicting an example of the storage contents of the sentence database 220. In FIG. 4, the sentence database 220 has fields for the sentence vectors Q (question) and A (answer), and stores sentence data (for example, sentence data 401, 402) as records by setting information in each field.

Here, the sentence vector represents characteristics of the question sentence depicted in Q (question). The Q (question) indicates the question sentence. The question sentence consists of one or more sentences. A (answer) indicates an answer to the question indicated by the Q (question). The answer consists of one or more sentences. A pair of the question (Q) and the answer (A) is created based on, for example, past Q&A (question and answer) and question and answer cases accumulated as knowledge.

Here, the sentence vector is information representing the characteristics of the question (Q), but is not limited hereto. For example, the sentence vector may be information representing the characteristics of the question (Q) and the answer (A). The sentence data is stored in a QA format, but is not limited hereto. For example, the sentence data may be information regarding a sentence extracted from, for example, a textbook and/or manual related to a certain field.

Next, an example of a functional configuration of the answer generating device 201 according to the first embodiment is described.

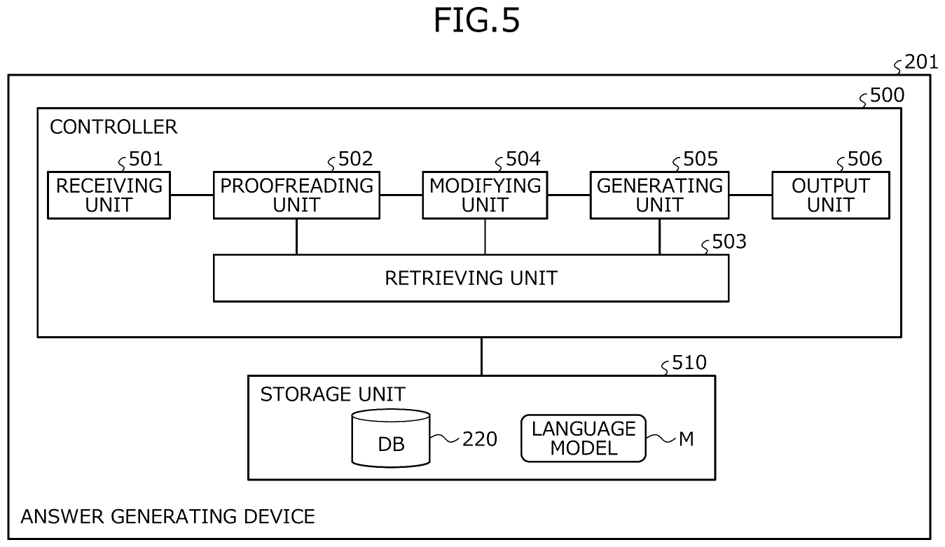

FIG. 5 is a block diagram depicting an example of a functional configuration of the answer generating device 201 according to the first embodiment. In FIG. 5, the answer generating device 201 includes a receiving unit 501, a proofreading unit 502, a retrieving unit 503, a modifying unit 504, a generating unit 505, an output unit 506, and a storage unit 510. The receiving unit 501 to the output unit 506 are functions that constitute a controller 500, and for example, the functions are achieved by causing the CPU 301 to execute a program stored in a storage device such as the memory 302, the disk 304, or the removable recording medium 307 depicted in FIG. 3, or by the communications I/F 305. Processing results of the functional units are stored, for example, to a storage device such as the memory 302 or the disk 304. The storage unit 510 is implemented by a storage device such as the memory 302 or the disk 304. For example, the storage unit 510 stores the sentence database 220 as depicted in FIG. 4. In FIG. 5, a DB 220 corresponds to the sentence database 220.

The receiving unit 501 receives the first question sentence. The first question sentence asks about something unclear or suspicious, and is expressed by, for example, one or more sentences. The first question sentence is input, for example, on an inquiry screen (not depicted) displayed on the client device 202 depicted in FIG. 2. For example, the receiving unit 501 receives the first question sentence by receiving the first question sentence input from the client device 202.

For example, the receiving unit 501 receives the first question sentence by receiving the first question sentence input from the client device 202. The receiving unit 501 may receive the first question sentence by a user operation input using a non-depicted input device of the device itself.

The proofreading unit 502 proofreads the first question sentence received. Here, proofreading refers to correcting errors such as typos, omissions, and grammatical errors in the first question sentence. For example, the proofreading unit 502 may proofread the first question sentence using a language model M. The language model M is a learning model for generating sentences.

The language model M is, for example, the Large Language Models (LLM). The language model M may be a Small Language Models (SLM). The language model M includes, for example, first, second, and third language models.

The first language model is used in generating the second question sentence by the modifying unit 504. The second language model is used in proofreading the first question sentence by the proofreading unit 502. The third language model is used in generating answers by the generating unit 505. The first, second, and third language models may be the same.

The first, second, and third language models may be different from each other. For example, the first language model may be a machine learning model specialized for modifying a style of the sentence to generate a new sentence. The second language model may be a machine learning model specialized for proofreading the sentence. The third language model may be a machine learning model specialized for generating the answer to the question sentence.

The language model M is stored, for example, in the storage unit 510. The language model M may be stored in other computers to which the answer generating device 201 has access. In this case, the answer generating device 201 can utilize the language model M by accessing the other computers.

Explaining in more detail, for example, the proofreading unit 502 creates a prompt (statement) that instructs correction of errors such as typos and omissions in the first question sentence so as to maintain the same meaning as the first question sentence. Then, the proofreading unit 502 proofreads the first question sentence by providing the created prompt to the language model M (second language model).

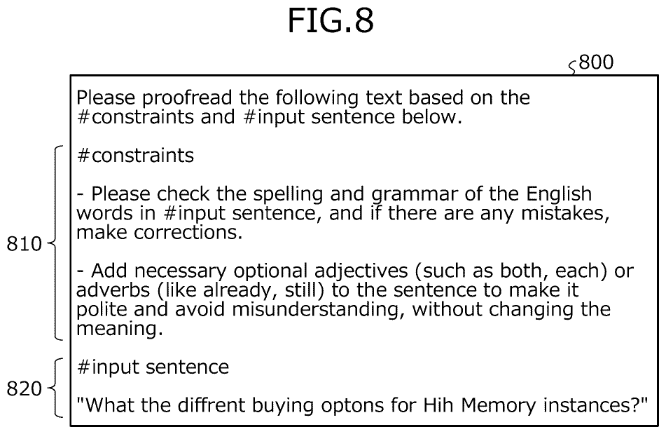

A specific example of the prompt for proofreading is described later with reference to FIG. 8. Any existing technology may be used for proofreading the first question sentence.

The retrieving unit 503 refers to the storage unit 510 to retrieve the first sentence data related to the proofread first question sentence. Here, the storage unit 510 stores multiple sentence data. The sentence data represents, for example, a sentence. A sentence is created based on, for example, the past Q&A and question and answer cases. The sentence may be extracted from a textbook, a manual, etc.

The sentence data may represent, for example, a sentence and the feature amount of the sentence. The feature amount of the sentence is information representing the feature of the sentence and is, for example, a sentence vector. A sentence vector is a fixed-length vector obtained by vectorizing the sentence. The sentence vector may be calculated from the entire sentence represented by the sentence data or from a part of the sentence represented by the sentence data (for example, only Q of QA). Any existing technology may be used for vectorizing the sentence.

For example, the retrieving unit 503 calculates the first sentence vector by vectorizing the proofread first question sentence. Then, the retrieving unit 503 compares the calculated first sentence vectors and the sentence vectors represented by each sentence data in the sentence database 220 as depicted in FIG. 4 and thereby retrieves the first sentence data representing a sentence having a similar characteristic to the proofread first question sentence.

More specifically, for example, the retrieving unit 503 calculates a vector-to-vector distance between sentence vectors represented by each sentence data in the sentence database 220 and the first sentence vectors. Further, the retrieving unit 503 may retrieve a sentence data in which the calculated vector-to-vector distance is equal to or less than a first threshold value, as the first sentence data. The first threshold value can be set arbitrarily.

The modifying unit 504 generates the second question sentence in which a style of the proofread first question sentence is modified so as to maintain the same meaning as that of the proofread first question by using the language model M (first language model) according to the retrieved first sentence data. Here, the style is, for example, a feature of sentence expression appearing in the words, idioms, rhetoric, etc. used in the sentence.

For example, the style of the sentence represented by the sentence data may reflect the writer's idiosyncrasies. In case of a sentence related to a specific field, the sentence represented by the sentence data may use expressions specific to that field or technical terms. In contrast, the first question sentence does not necessarily use the same sentence expression as the sentence represented by the sentence data.

Thus, the modifying unit 504, for example, generates the second question sentence by modifying the style of the proofread first question sentence according to the style of the sentence represented by the retrieved first sentence data. For example, the modifying unit 504 creates a prompt to instruct the user to rewrite the proofread first question sentence so as to maintain the meaning of the proofread first question sentence by using as much of the style (such as phrases, idioms, and rhetoric) used in the sentence represented by the first sentence data as possible. Then, the modifying unit 504 generates the second question sentence by providing the created prompt to the language model M.

The retrieving unit 503 refers to the storage unit 510 and retrieves a second sentence data related to the generated second question sentence. For example, the retrieving unit 503 vectorizes the generated second question sentence, thereby calculating a second sentence vector. Then, the retrieving unit 503 compares the calculated second sentence vector and sentence vectors represented by sentence data in the sentence database 220 and thereby retrieves a second sentence data representing a sentence having similar characteristics to the second question sentence.

Explaining in more detail, for example, the retrieving unit 503 calculates a vector-to-vector distance between the sentence vectors represented by the sentence data in the sentence database 220 and the second sentence vectors. Then, the retrieving unit 503 may retrieve sentence data in which the calculated vector-to-vector distance is equal to or less than a second threshold as the second sentence data.

The second threshold can be set arbitrarily. For example, the second threshold may be set to a value smaller than the first threshold. Therefore, the retrieving unit 503 can retrieve the second sentence data under stricter conditions (more similar data is retrieved) than a case of retrieving the first sentence data related to the proofread first question sentences.

The generating unit 505 uses the language model M (third language model) and generates an answer to the first question sentence, based on the retrieved second sentence data and the generated second question sentence. For example, based on the second sentence data and the second question sentence, the generating unit 505 generates a prompt to instruct generation of an answer to the second question. Then, the modifying unit 504 generates an answer to the first question by providing the generated prompt to the language model M.

The generated answer is associated with the first question sentence and is output by the output unit 506. For example, the output format of the output unit 506 includes storage to a storage device such as the memory 302 and the disk 304, transmitting to other computers via the communications I/F 305, display on a screen (not depicted), printed output to a printer (not depicted), and the like.

For example, the output unit 506 may associate the received first question sentence to transmit a response result representing the generated answer to the client device 202. As a result, in the client device 202, for example, the generated answer is associated with the first question sentence and is displayed on the inquiry screen (not depicted).

In the description above, while the retrieving unit 503 retrieves the first sentence data related to the proofread first question sentence, configuration is not limited hereto. For example, the retrieving unit 503 may retrieve the first sentence data related to the received first question sentence (the first question sentence not proofread). In this case, the modifying unit 504 may generate a second question sentence by modifying the style of the received first question sentence (the first question sentence not proofread) in response to the retrieved first sentence data.

The generating unit 505 may generate, based on the retrieved first sentence data (sentence data related to the proofread first question sentence) and the proofread first question sentence, the answer to the first question sentence using the language model M (third language model).

When the first threshold value used in retrieving the first sentence data is too low, retrieval of the related sentence data may be difficult due to, for example, differences in the style. On the other hand, when the first threshold value is too high, the retrieval accuracy of the related sentence data may decrease. The value to be set as the first threshold value may differ depending on the contents of the question sentence and the contents of the sentence in the sentence database 220.

Thus, the retrieving unit 503 may prepare multiple patterns of the first threshold value and retrieve the first sentence data for each pattern. For example, patterns 1 to 3 are assumed to be prepared in advance as the multiple patterns. In pattern 1, the first threshold value is set to a value equal to the second threshold value used in retrieving the second sentence data.

In pattern 2, the first threshold value is set to a value approximately 10% larger than the second threshold value. In pattern 3, the first threshold value is set to a value approximately 20% larger than the second threshold value. For each of patterns 1 to 3, the retrieving unit 503 may retrieve a sentence data for which the calculated vector-to-vector distance is equal to or smaller than the first threshold value as the first sentence data.

In this case, for each of the patterns 1 to 3, the answer generating device 201 may generate the second question sentence, retrieve the second sentence data, and generate and output the answer. Thus, the answer generating device 201 can output an answer to the first question sentence for each of the patterns 1 to 3.

The functional units (receiving unit 501 to output unit 506) of the answer generating device 201 may be implemented by multiple computers (for example, the answer generating device 201 and the client device 202) in the answer generating system 200. In this case, communication between the functional units of different computers is performed, for example, by transmission and reception between the functional units via the network 210.

An example of operation of the answer generating device 201 according to the first embodiment is described.

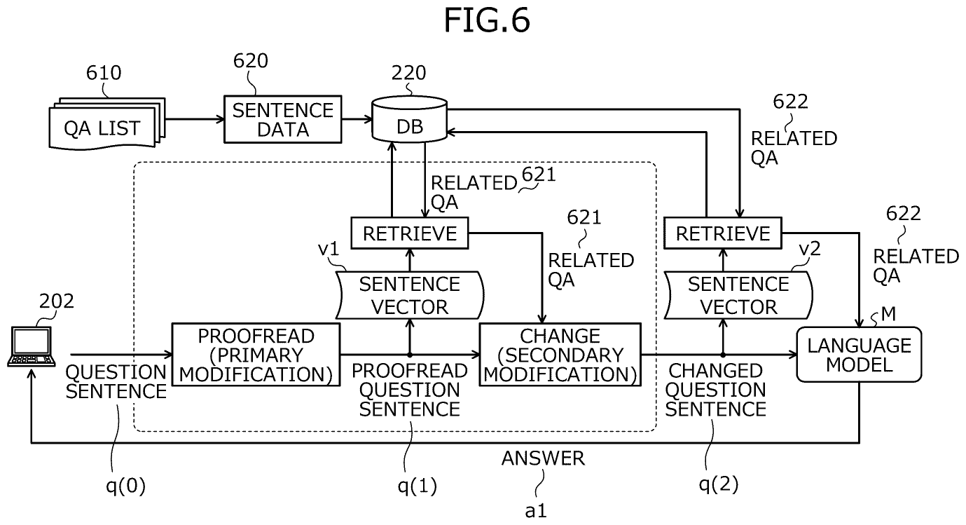

FIG. 6 is an explanatory diagram depicting an example of operation of the answer generating device 201 according to the first embodiment. In FIG. 6, the answer generating device 201 generates sentence data 620 with reference to a QA list 610, and the created sentence data 620 is then registered in the sentence database 220. In FIG. 6, the DB 220 corresponds to the sentence database 220.

The QA list 610 is a list of past QAs. For example, the answer generating device 201 calculates the sentence vector by vectorizing the question sentence (Q) for each QA in the QA list 610. The answer generating device 201 may calculate the sentence vector by vectorizing the entire QA including the question sentence (Q) and the answer (A).

Thereafter, the answer generating device 201 creates the sentence data 620 including the calculated sentence vector and the QA, and the created sentence data 620 is registered in the sentence database 220. The sentence data 620 corresponds to, for example, the sentence data 401 and 402 depicted in FIG. 4.

Thus, the answer generating device 201 can convert information (past Q&A) accumulated as knowledge to a DB. Furthermore, the answer generating device 201 can register the sentence vector and the Q&A together in order to facilitate retrieving the related information (Q&A) from the sentence database 220.

Here, a case is assumed in which the answer generating device 201 receives a question sentence q(0) from the client device 202. The question sentence q(0) corresponds to the first question.

First, the answer generating device 201 proofreads the received question sentence q(0) using the language model M. Here, the proofread question sentence q(0) is referred to as “question sentence q(1)”. A process of proofreading the question sentence q(0) corresponds to a primary modification of the question sentence q(0).

Thereafter, the answer generating device 201 refers to the sentence database 220 to retrieve a related Q&A related to the proofread question sentence q(1). For example, the answer generating device 201 calculates a sentence vector v1 by vectorizing the proofread question sentence q(1). The sentence vector v1 corresponds to the first sentence vector.

Then, the answer generating device 201 compares sentence vectors represented by sentence data (for example, sentence data 620) in the sentence database 220 with the calculated sentence vector v1 and thereby retrieves, as the related QAs, sentence data representing sentences having similar characteristics to the proofread question sentence q(1).

Here, a related QA 21 related to the proofread question sentence q(1) is assumed to be retrieved. The related QA 621 corresponds to the first sentence data.

In this case, according to the retrieved related QA 621, the answer generating device 201 uses the language model M and generates a question sentence q(2) in which a style of the proofread question sentence q(1) is changed so as not to change a meaning of the proofread question sentence q(1). A process of changing the style of the proofread question sentence q(1) corresponds to a secondary modification of the question sentence q(0). The changed question sentence q(2) corresponds to the second question sentence.

Thereafter, the answer generating device 201 refers to the sentence database 220 to retrieve a related QA related to the changed question sentence q(2). For example, the answer generating device 201 calculates a sentence vector v2 by vectorizing the changed question q(2). The sentence vector v2 corresponds to the second sentence vector.

Then, the answer generating device 201 compares the sentence vectors represented by each sentence data in the sentence database 220 with the calculated sentence vector v2 and thereby retrieves sentence data representing sentences with similar features to the changed question q(2), as the related QAs.

Here, a related QA 622 related to the changed question sentence q(2) is assumed to be retrieved. The related QA 622 corresponds to the second sentence data.

Next, based on the retrieved related QA 622 and the changed question sentence q(2), the answer generating device 201 generates an answer to the question sentence q(0) using the language model M. Here, an “answer a1” is assumed to be generated as the answer to the question sentence q(0). In this case, the answer generating device 201 associates the generated answer a1 and the received question sentence q(0) and outputs both to the client device 202.

Thus, the answer generating device 201 can improve the retrieval accuracy for information (related QA 622) related to the user's question sentence q(0), resulting in improved accuracy in generating the answer (answer a1) to the user's question sentence q(0).

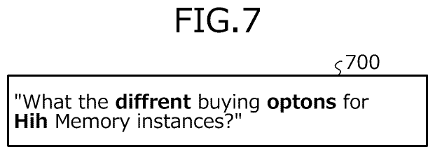

Next, modification examples of the question sentences (primary modification, secondary modification) are described using FIGS. 7 to 11. First, the user's question sentence is described using FIG. 7.

FIG. 7 is an explanatory diagram depicting an example of a user's question sentence. In FIG. 7, a question sentence 700 represents a user's question sentence (first question sentence). The answer generating device 201 receives, for example, the question sentence 700 from the client device 202. In the example depicted in FIG. 6, the question sentence 700 corresponds to the question sentence q(0).

Here, the question sentence 700 includes typographical errors. Therefore, when a form of the question sentence 700 is maintained, the vector-to-vector distances to the related QAs may become large when vectorizing the question sentence 700 to retrieve the related QAs, whereby the retrieval accuracy decreases.

Therefore, the answer generating device 201 proofreads the question sentence 700 using the language model M. For example, the answer generating device 201 proofreads the question sentence 700 by providing a proofreading prompt as depicted in FIG. 8 to the language model M.

Here, the proofreading prompt is described using FIG. 8.

FIG. 8 is an explanatory diagram depicting a specific example of the proofreading prompt. In FIG. 8, a prompt 800 instructs modification of errors such as typos, omissions, and grammatical mistakes in the question sentence 700 so as to maintain the same meaning as the question sentence 700 (see FIG. 7).

For example, the prompt 800 is a statement which instructs the language model M to proofread the question sentence 700 based on #constraint 810 and #input sentence 820. The #input sentence 820 corresponds to the question sentence 700. The answer generating device 201 can proofread the question sentence 700 by providing the prompt 800 to the language model M.

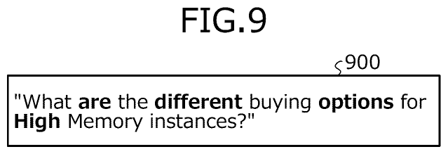

Next, a question sentence after the primary modification (proofreading) is described using FIG. 9.

FIG. 9 is an explanatory diagram depicting an example of the question sentence after the primary modification. In FIG. 9, a question sentence 900 represents the question sentence after the primary modification (proofreading). In the question sentence 900, the errors such as typos and omissions in the question sentence 700 depicted in FIG. 7 have been corrected. In the example depicted in FIG. 6, the question sentence 900 corresponds to the question sentence q(1).

The answer generating device 201 refers to the sentence database 220 and retrieves a related QA related to the question sentence 900. Here, a case is assumed in which the sentence data 402 (QA) depicted in FIG. 4 is retrieved from the sentence database 220 as the related QA related to the question sentence 900. The sentence data 402 is assumed to be retrieved by comparing a sentence vector of the question sentence 900 with a sentence vector of the entire sentence (QA) represented by the sentence data 402.

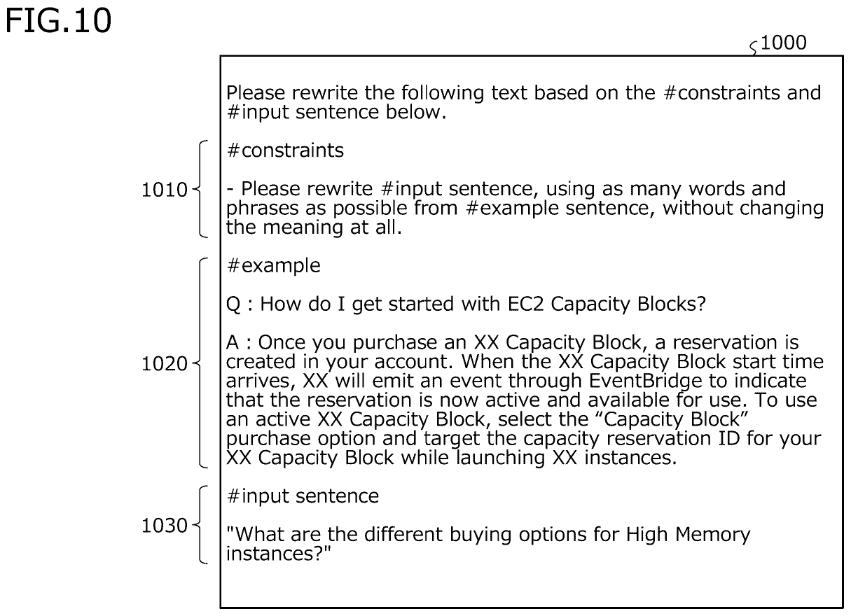

In this case, according to the sentence data 402, the answer generating device 201 uses the language model M and generates a question sentence in which the style of the question sentence 900 is changed so as to maintain the same meaning as the question sentence 900. For example, the answer generating device 201 changes the style of the question sentence 900 by providing a style-changing prompt as depicted in FIG. 10 to the language model M.

Here, the style-changing prompt is described with reference to FIG. 10.

FIG. 10 is an explanatory diagram depicting a specific example of the style-changing prompt. In FIG. 10, a prompt 1000 instructs the rewriting of the question sentence 900 (see FIG. 9) using as many words, phrases, rhetoric, and the like used in the related QA represented by the sentence data 402 as possible so as to maintain the same meaning as the question sentence 900.

For example, the prompt 1000 is a statement that instructs the language model M to rewrite, based on #constraints 1010 and an #input sentence 1030, the #input sentence 1030, using as many words and phrases in an #example 1020 as possible without changing the meaning at all. The #input sentence 1030 corresponds to the question sentence 900.

By providing the prompt 1000 to the language model M and using the words and phrases used in the related QA (sentence data 402), the answer generating device 201 can rewrite the question sentence 900 so as to maintain the meaning thereof.

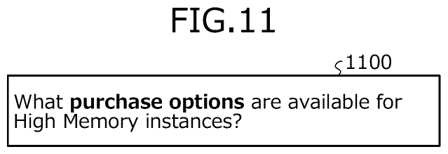

Here, a question sentence after the secondary modification (after changing writing styles) is described with reference to FIG. 11.

FIG. 11 is an explanatory diagram depicting an example of the question sentence after the secondary modification. In FIG. 11, a question sentence 1100 indicates the question sentence after the secondary modification (after changing the writing styles). In the question sentence 1100, the question sentence 900 depicted in FIG. 9 is modified so as not to change the meaning by using a phrase “purchase option”, which is a characteristic expression in the related QA (sentence data 402). In the example depicted in FIG. 6, the question sentence 1100 corresponds to the question sentence q(2).

The answer generating device 201 uses the question sentence 1100 customized to match the writing style in the sentence database 220 to retrieve the related QAs again and thereby facilitates hitting more appropriate information and thus, improving the retrieval accuracy of the related QAs used to generate the answers.

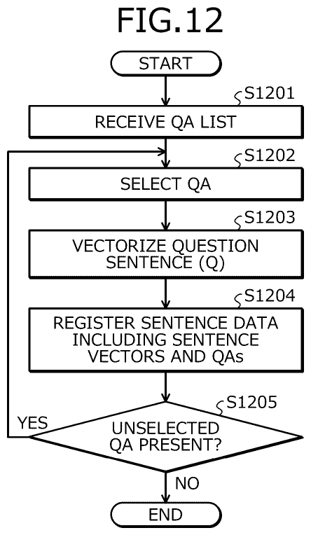

Next, various processing procedures of the answer generating device 201 according to the first embodiment are described. First, a DB registration process procedure of the answer generating device 201 is described using FIG. 12.

FIG. 12 is a flowchart depicting an example of the DB registration process procedure of the answer generating device 201 according to the first embodiment. In the flowchart depicted in FIG. 12, first, the answer generating device 201 receives a QA list (step S1201). For example, the answer generating device 201 receives the QA list from a management device (not depicted). The management device is, for example, a computer used by an administrator of the answer generating system 200.

Then, the answer generating device 201 selects an unselected QA from the received QA list (step S1202). Thereafter, the answer generating device 201 calculates the sentence vector by vectorizing a question sentence (Q) of the selected QA (step S1203).

Then, the answer generating device 201 registers sentence data including the calculated sentence vectors and the selected QAs into the sentence database 220 (step S1204). Thereafter, the answer generating device 201 judges whether there is an unselected QA that has not been selected from the QA list (step S1205).

Here, when an unselected QA is present (step S1205: YES), the answer generating device 201 returns to the step S1202. On the other hand, when no unselected QA is present (step S1205: NO), the answer generating device 201 ends a series of processes according to this flowchart.

Thus, the answer generating device 201 can convert the past QAs accumulated as knowledge to a DB and can also register sentence vectors for quantitatively evaluating the relevance between text data. In the step S1203, the answer generating device 201 may calculate the sentence vector by vectorizing the entire QA including the question sentence (Q) and the answer (A).

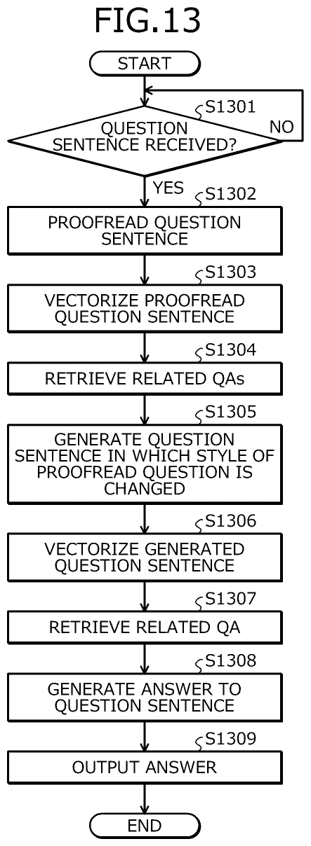

Next, an answer generation process procedure of the answer generating device 201 is described with reference to FIG. 13.

FIG. 13 is a flowchart depicting an example of the answer generation process procedure of the answer generating device 201 according to the first embodiment. In the flowchart depicted FIG. 13, first, the answer generating device 201 judges whether a question sentence (first question sentence) has been received (step S1301). Here, the answer generating device 201 waits for a question sentence to be received (step S1301: NO).

Then, when question sentence has been received (step S1301: YES), the answer generating device 201 proofreads the received question sentence using the language model M (step S1302). Thereafter, the answer generating device 201 calculates a sentence vector by vectorizing the proofread question sentence (step S1303).

Then, based on the calculated sentence vector, the answer generating device 201 retrieves related QAs having similar features to the proofread question sentence, from the sentence database 220 (step S1304). For example, the answer generating device 201 calculates vector-to-vector distances between sentence vectors represented by sentence data in the sentence database 220 and the calculated sentence vectors, and retrieves sentence data in which the calculated vector distances are equal to or less than the first threshold, as the related QA.

Next, according to the style of the retrieved related QA, the answer generating device 201 uses the language model M and generates a question sentence (second question sentence) in which the style of the proofread question is changed so as to maintain the same meaning as the proofread question (step S1305). Thereafter, the answer generating device 201 calculates the sentence vector by vectorizing the generated question sentence (step S1306).

Then, based on the sentence vector calculated at step S1306, the answer generating device 201 retrieves related QA having features similar to the generated question sentence, from the sentence database 220 (step S1307). For example, the answer generating device 201 calculates the vector distances between the sentence vectors represented by sentence data in the sentence database 220 and the calculated sentence vectors, and retrieves sentence data in which the calculated vector distance is equal to or less than a second threshold as the related QA.

Thereafter, based on the related QA retrieved at the step S1307 and the generated question sentence, the answer generating device 201 uses the language model M and generates an answer to the received question sentence (step S1308). Then, the answer generating device 201 associates and outputs the generated answer and the received question sentence (step S1309), and ends a series of processes according to this flowchart.

Thus, the answer generating device 201 can output the answer to the received question sentence. The answer generating device 201 may omit the process at the step S1302. In this case, the answer generating device 201 performs the processes at steps S1303 to S1305 for the question sentence received at the step S1301.

As described, according to the answer generating device 201 in the first embodiment, the first sentence data related to the first question sentence can be retrieved by referring to the storage unit 510 that stores multiple sentence data, and according to the retrieved first sentence data, the second question sentence can be generated in which the style of the first question sentence has been changed so as to maintain the meaning of the first question sentence, by using the language model M (first language model). The language model M is a machine learning model for generating sentences and is, for example, the Large Language Models (LLM).

Thus, the answer generating device 201 can improve the retrieval accuracy of information related to the question sentence (for example, related QA) in generating an answer to the question sentence (first question sentence). For example, by using technical terms and phrases used in the sentence represented by the first sentence data, the answer generating device 201 can rewrite the first question sentence so as not to change the meaning thereof. Therefore, the answer generating device 201 can make the style of the question sentence similar to the sentence in the DB (e.g., the sentence database 220), and can generate a question sentence that is more likely to hit a more appropriate related QA.

According to the answer generating device 201, the first question sentence can be proofread using the language model M (second language model). Then, according to the answer generating device 201, the first sentence data related to the proofread first question sentence is retrieved by referring to the storage unit 510 and according to the retrieved first sentence data, the second question sentence can be generated in which the style of the first proofread question sentence is changed so as not to be different from the meaning of the first proofread question sentence, by using the language model M (first language model).

Thus, the answer generating device 201 can modify typos, omissions, grammatical errors, and the like in the question, and can further improve the retrieval accuracy of information related to the question sentence.

According to the answer generating device 201, the storage unit 510 is referenced to retrieve the second sentence data related to the generated second question sentence, and an answer to the first question sentence can be generated using the language model M (third language model) based on the retrieved second sentence data and the generated second question sentence.

Thus, the answer generating device 201 can generate the answer using more appropriate information related to the question sentence (for example, related QA) to improve the accuracy in generating the answer to the question sentence.

According to the answer generating device 201, the storage unit 510 is referenced to compare the feature amount of the sentence represented by the sentence data included in the multiple sentence data with that of the first question sentence, and thereby the first sentence data representing the sentence with similar features to the first question sentence can be retrieved. The storage unit 510 stores multiple sentence data including sentence data representing a sentence and the feature amount of the sentence.

Therefore, the answer generating device 201 can retrieve sentences in the DB (e.g., the sentence database 220) that have similar features to the first question sentence, as information related to the first question sentence. The answer generating device 201 stores a feature amount of each sentence in the DB (for example, sentence vector), thereby reducing the processing time and processing load required for the retrieval process compared to a case where the feature amount of each sentence is calculated each time when information related to the first question sentence is retrieved.

According to the answer generating device 201, the second sentence data representing a sentence with similar features to the second question sentence can be retrieved by referring to the storage unit 510 to compare the feature amount of the sentence represented by sentence data included among the multiple sentence data with that of the second question sentence. The storage unit 510 stores multiple sentence data including sentence data representing sentences and the feature amounts of the sentences.

Therefore, of the sentences in the DB, the answer generating device 201 can retrieve a sentence with similar features to the second question sentence, as information related to the second question sentence. By storing the feature amount (e.g., sentence vector) of each sentence to the DB in advance, the answer generating device 201 can reduce the processing time and processing load required for the retrieval process compared with a case where the feature amount of each sentence is calculated each time the information related to the second question sentence is retrieved.

According to the answer generating device 201, the generated answer can be associated with the first question sentence and output.

Therefore, the answer generating device 201 can provide a highly accurate answer to the question sentence from the user.

Next, the answer generating device 201 according to a second embodiment is described. Note that the same reference numerals may be used to designate parts similar to those described in the first embodiment and illustration and explanation thereof are omitted hereinafter.

In the second embodiment, in a case that a style (e.g., characteristic phrases or idioms) often used in the related Q&A is obvious, a generation method is described which prepares information representing the style in advance to be used in changing the style of the question sentence.

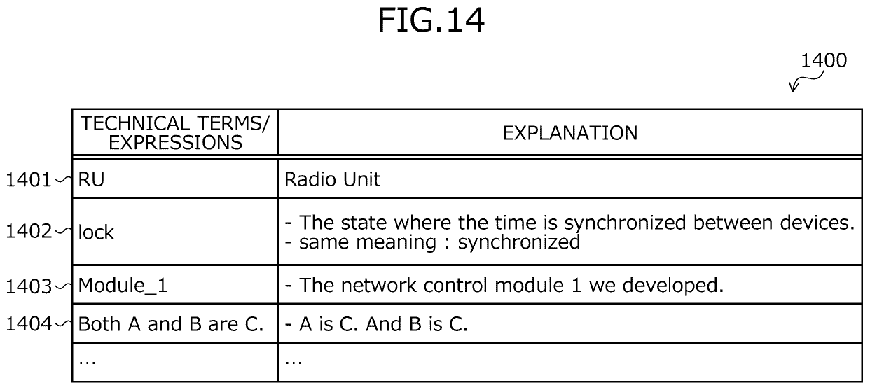

For example, in a case of a sentence related to a specific field, the terms (technical terms) and expressions specific to that field may be often used. In contrast, such technical terms and expressions are not necessarily used in the question sentence of the user. By referring to a sentence feature table 1400 as depicted in FIG. 14 described later, the answer generating device 201 generates a new question sentence in which the style of the question sentence has changed.

First, contents stored in the sentence feature table 1400 used by the answer generating device 201 according to the second embodiment are described.

FIG. 14 is an explanatory diagram depicting an example of the contents stored in the sentence feature table 1400. In FIG. 14, the sentence feature table 1400 has fields for technical terms/expressions and explanations, and by setting information in each field, sentence feature data (for example, sentence feature data 1401 to 1404) are stored as records.

Here, the technical terms/expressions indicate technical terms or characteristic expressions that are often used in sentences represented by the sentence data in the sentence database 220. The sentences are, for example, related to a specific field. In the example depicted in FIG. 14, the specific field is “network”. The explanations are information that can specify different terms/expressions that are synonymous with the technical terms/expressions.

For example, an explanation may be a term which is synonymous with a technical term and is used for general purposes. In a case where a technical term is an abbreviation, the explanation may be one indicating a formal name of the technical term (for example, the sentence feature data 1401). An explanation may be a sentence explaining the meaning of a technical term (for example, the sentence feature data 1402 and 1403). An explanation may be synonymous with a characteristic phrase and indicates a phrase used for general purposes (for example, the sentence feature data 1404).

The sentence feature table 1400 may be automatically created by the answer generating device 201 based on information accumulated as knowledge. The sentence feature table 1400 may be manually created by, for example, the administrator of the answer generating system 200.

Next, an example of a functional configuration of the answer generating device 201 according to the second embodiment is described.

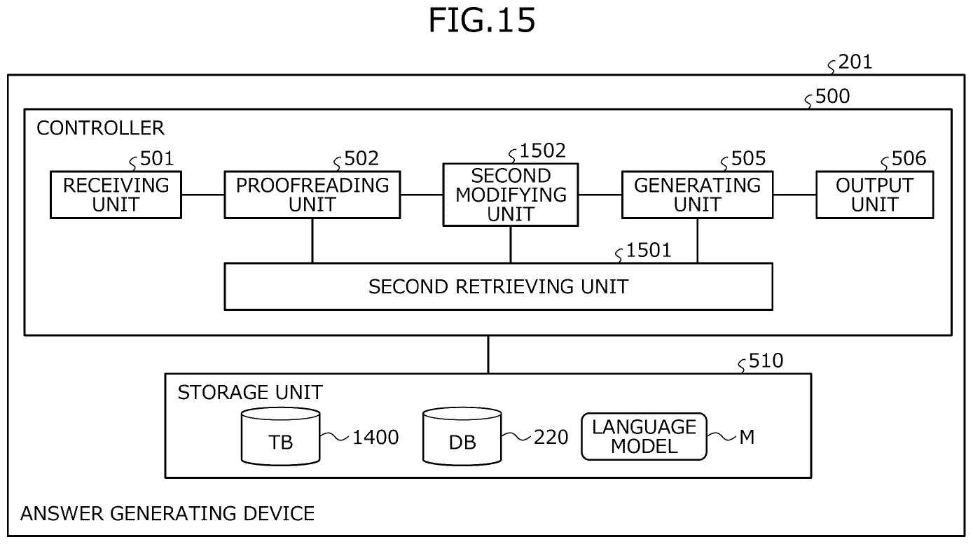

FIG. 15 is a block diagram depicting an example of the functional configuration of the answer generating device 201 according to the second embodiment. In FIG. 15, the answer generating device 201 includes the receiving unit 501, the proofreading unit 502, the generating unit 505, the output unit 506, the storage unit 510, a second retrieving unit 1501, and a second modifying unit 1502. The receiving unit 501 to the second modifying unit 1502 are functions that constitute the controller 500 and for example, the functions thereof are achieved by causing the CPU 301 to execute a program stored in a storage device such as the memory 302, the disk 304, or the removable recording medium 307 depicted in FIG. 3, or by the communications I/F 305. The processing results of the functional units are stored to a storage device such as the memory 302 or the disk 304.

Hereinafter, among the functional units of the answer generating device 201 according to the second embodiment, functional units different from those of the answer generating device 201 according to the first embodiment are described.

Here, the storage unit 510 stores multiple sentence data. The multiple sentence data includes sentence data representing a sentence. A sentence is, for example, related to a specific field (area). The multiple sentence data also includes sentence data representing a correspondence relationship between a style used in a sentence represented by at least any of the sentence data included in the multiple sentence data and a different style synonymous with the style.

The style is represented by, for example, words or diction. For example, the sentence data may represent a correspondence relationship between characteristic words used in a sentence represented by at least any of the sentence data included among multiple sentence data and a different diction synonymous with the words. The characteristic words are, for example, technical terms used in a sentence related to a specific field.

The sentence data may also represent a correspondence relationship between a characteristic diction used in the sentence represented by at least any of the sentence data included among the sentence data and a different diction synonymous with the diction. The characteristic diction is, for example, a characteristic expression used in a sentence related to a specific field.

For example, the storage unit 510 stores the sentence database 220 as depicted in FIG. 4 and the sentence feature table 1400 as depicted in FIG. 14. The sentence data in the sentence database 220 and the sentence feature data in the sentence feature table 1400 correspond to an example of the sentence data stored in the storage unit 510. In FIG. 15, the DB 220 corresponds to the sentence database 220. A TB 1400 corresponds to the sentence feature table 1400.

The second retrieving unit 1501 refers to the storage unit 510 and retrieves a first sentence data which represents a correspondence relationship between a first writing style included in the proofread first question sentence and a second writing style which is synonymous with the first writing style and is used in a sentence represented by at least any of the sentence data included in multiple sentence data.

The proofread first question sentence is the first question sentence proofread by the proofreading unit 502. The multiple sentence data is the multiple sentence data stored in the storage unit 510. The first sentence data corresponds to sentence data related to the first question sentence. The writing style is expressed by, for example, the words and the diction.

For example, the second retrieving unit 1501 may refer to the storage unit 510 to retrieve a first sentence data that represents a correspondence relationship between a first word included in the proofread first question sentence and a second word synonymous with the first words and phrases and is used in a sentence represented by at least any of the sentence data included in the multiple sentence data. Here, the first words are, for example, general-purpose words that are synonymous with technical terms in a specific field and formal names of the technical terms. The second words are, for example, technical terms in a specific field.

More specifically, for example, from the sentence feature table 1400, the second retrieving unit 1501 may retrieve sentence feature data in which the words depicted in the description field is “a first word” as the first sentence data. The second retrieving unit 1501 may also retrieve, from the sentence feature table 1400, sentence feature data in which the words depicted in the description field is “a first word” as the first sentence data.

The second retrieving unit 1501 may also refer to the storage unit 510 to retrieve a first sentence data that represents a correspondence relationship between a first diction included in the proofread first question sentence and a second diction that is synonymous with the first diction and is used in a sentence represented by at least any of the sentence data included in multiple sentence data.

Here, the first diction is, for example, a general-purpose expression such as “A is C. And B is C.”. The second diction is, for example, a characteristic expression such as “Both A and B are C.”. More specifically, for example, the second retrieving unit 1501 may retrieve, from the sentence feature table 1400, sentence feature data in which the diction depicted in the description field is a “first diction” as the first sentence data.

According to the first sentence data retrieved by the second retrieving unit 1501, the second modifying unit 1502 uses the language model M and generates a second question sentence in which the first style included in the proofread first question has been changed to the second style so that the meaning does not change from the first question sentence proofread by the proofreading unit 502.

For example, the second modifying unit 1502 creates a prompt instructing the rewriting of the proofread first question sentence using the second style (the second word or the second diction) represented by the first sentence data so that the meaning does not change from the proofread first question sentence. Then, the modifying unit 504 generates the second question sentence by providing the created prompt to the language model M.

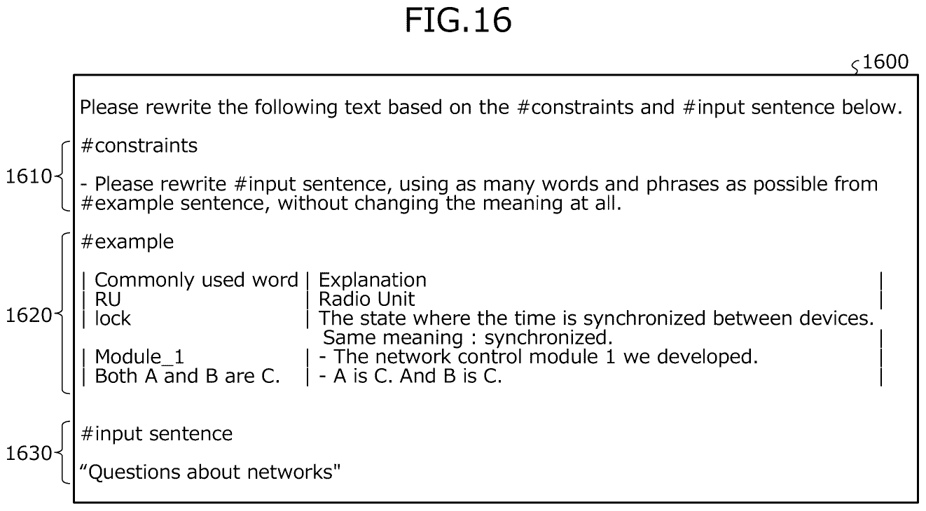

The prompt for modifying styles is described later with reference to FIG. 16.

The second retrieving unit 1501 also refers to the storage unit 510 to retrieve second sentence data related to the second question sentence generated by the second modifying unit 1502. Then, based on the second sentence data retrieved by the second retrieving unit 1501 and the second question sentence generated by the second modifying unit 1502, the generating unit 505 uses the language model M to generate an answer to the first question sentence.

In the above description, while the second retrieving unit 1501 retrieves the first sentence data for the proofread first question sentence, configuration is not limited hereto. For example, the second retrieving unit 1501 may retrieve the first sentence data for the received first question sentence (the first question sentence not proofread). In this case, the second modifying unit 1502 may generate the second question sentence from the received first question sentence (the first question not proofread), according to the retrieved first sentence data.

Here, the prompt for modifying styles is described with reference to FIG. 16. Here, a case is assumed in the sentence feature data 1401 to 1404 in the sentence feature table 1400 are retrieved as the first sentence data.

FIG. 16 is an explanatory diagram depicting a specific example of the prompt for modifying styles. In FIG. 16, a prompt 1600 uses technical terms/expressions (corresponding to the second style) represented by the sentence feature data 1401 to 1404, instructing to rewrite the question sentence so that the meaning of the question sentence is not modified.

For example, the prompt 1600 is a statement that instructs the language model M to rewrite the #input sentence 1630 based on the #constraints 1610 and the #input sentence 1630, using as many words and phrases as possible from the #example 1620 without changing the meaning at all. The #input 1630 corresponds to the question sentence. In FIG. 16, “Questions about networks” in the #input sentence 1630 represents some kind of question sentence about networks.

By providing the prompt 1600 to the language model M, the answer generating device 201 can rewrite the question sentence so as not to change the meaning thereof, using technical terms and characteristic expressions represented by the sentence feature data 1401 to 1404.

An example of operation of the answer generating device 201 according to the second embodiment is described.

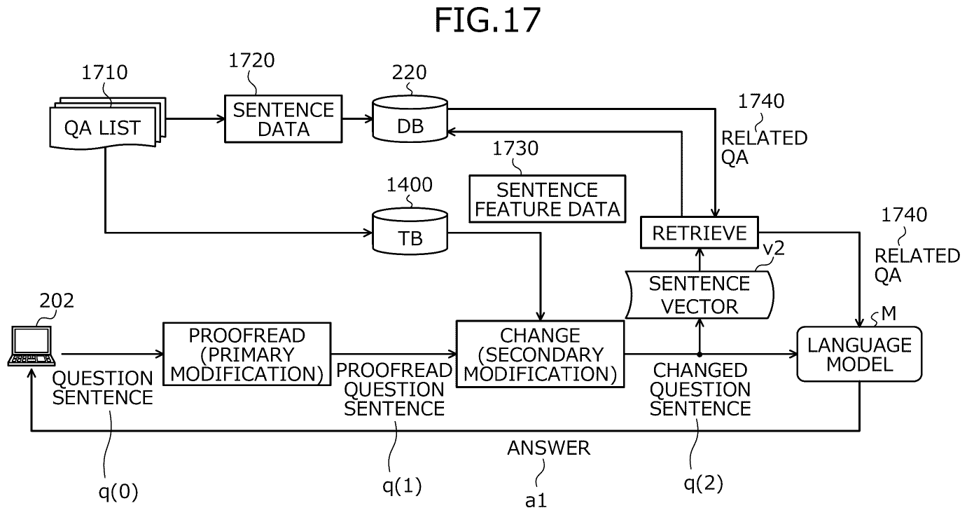

FIG. 17 is an explanatory diagram depicting an example of the operation of the answer generating device 201 according to the second embodiment. In FIG. 17, the answer generating device 201 refers to a QA list 1710, generates sentence data 1720, and registers the created sentence data 1720 in the sentence database 220.

The QA list 1710 is the list of past Q&As. The sentence data 1720 corresponds to, for example, the sentence data 401 and 402 depicted in FIG. 4. In FIG. 17, the DB 220 corresponds to the sentence database 220. The TB 1400 corresponds to the sentence features table 1400.

The answer generating device 201 also refers to the QA list 1710 to create the sentence features table 1400. For example, the answer generating device 201 extracts phrases (terms) and diction (expression) that are frequently used in Q&As in the Q&A list 1710 as the technical terms/phrases.

Thereafter, the answer generating device 201 creates a prompt to instruct to generate information (sentence feature data) indicating a correspondence relationship between the extracted technical terms/expressions and different phrases and dictions that are synonymous with the technical terms/expressions. The modifying unit 504 then provides the created prompt to the language model M to generate the sentence feature table 1400.

Thus, the answer generating device 201 allows the phrases and dictions frequently used in information accumulated as knowledge (past Q&A) to be listed and stored associated with different phrases and dictions that are synonymous thereto.

Here, a case is assumed where the answer generating device 201 receives the question sentence q(0) from the client device 202. The question sentence q(0) corresponds to the first question sentence.

First, the answer generating device 201 proofreads the received question sentence q(0) using the language model M. Here, the proofread question sentence q(0) is referred to as “question sentence q(1)”.

Thereafter, the answer generating device 201 refers to the sentence feature table 1400 to retrieve sentence feature data related to the proofread question sentence q(1). The sentence feature data to be retrieved, for example, indicates a correspondence relationship between the first style (phrases, diction, etc.) included in the proofread question q(1) and the second style that is synonymous with the first sentence style and used in the sentence in the sentence database 220.

Here, sentence feature data 1730 related to the proofread question sentence q(1) is assumed to be retrieved. The sentence feature data 1730 corresponds to the first sentence data.

In this case, according to the retrieved sentence feature data 1730, using the language model M, the answer generating device 201 generates a question sentence q(2) in which the first style included in the proofread question sentence q(1) is modified to the second style so as not to change the meaning of the question sentence q(2) from the proofread question sentence q(1). The modified question sentence q(2) corresponds to the second question sentence.

Next, the answer generating device 201 refers to the sentence database 220 to retrieve a related QA related to the modified question q(2). For example, the answer generating device 201 calculates a sentence vector v2 by vectorizing the modified question sentence q(2). The sentence vector v2 corresponds to a second sentence vector.

Then, the answer generating device 201 compares the sentence vectors represented by each sentence data in the sentence database 220 with the calculated sentence vector v2, thereby retrieving sentence data representing a sentence having similar characteristics to the modified question sentence q(2) as the related QA.

Here, a related QA1740 related to the modified question sentence q(2) is assumed to be retrieved. The related QA1740 corresponds to the second sentence data.

Next, the answer generating device 201 generates an answer to the question sentence q(0) using the language model M based on the retrieved related QA1740 and the modified question sentence q(2). Here, an “answer a1” is assumed to be generated as the answer to the question sentence q(0). In this case, the answer generating device 201 outputs the generated answer a1 to the client device 202 in association with the received question sentence q(0).

Thus, the answer generating device 201 can improve the retrieval accuracy of information (related QA 1740) related to the user's question sentence q(0) and ultimately improve the accuracy of generating the answer (answer a1) to the user's question sentence q(0).

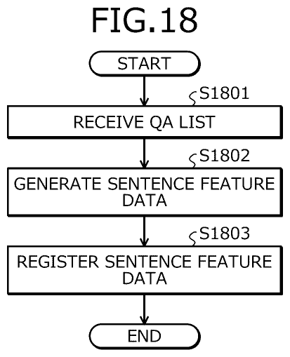

Next, various processing procedures of the answer generating device 201 according to the second embodiment is described. First, a table creation processing procedure of the answer generating device 201 is described using FIG. 18. A DB registration processing procedure of the answer generating device 201 is similar to the processing procedure depicted in FIG. 12, and therefore illustration and description thereof will be omitted.

FIG. 18 is a flowchart depicting an example of the table creation processing procedure of the answer generating device 201 according to the second embodiment. In the flowchart of FIG. 18, first, the answer generating device 201 receives a QA list (step S1801).

Following that, the answer generating device 201 refers to the received QA list to generate sentence feature data representing a correspondence relationship between technical terms/phrases in the QA list and different words and diction that are synonymous with the technical terms/phrases (step S1802). Then, the answer generating device 201 registers the created sentence feature data in the sentence feature table 1400 (step S1803) and ends a series of processes according to this flowchart.

Thus, the answer generating device 201 can list and hold information representing words and dictions that are frequently used in information (past QAs) accumulated as knowledge in association with different words and dictions that are synonymous with them.

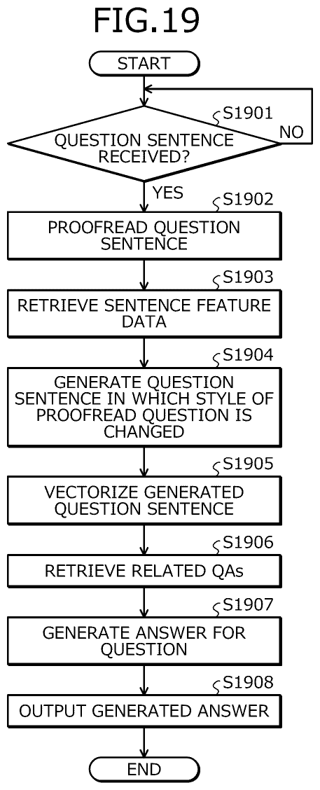

Next, an answer generation processing procedure of the answer generating device 201 is described using FIG. 19.

FIG. 19 is a flowchart depicting an example of the answer generation processing procedure of the answer generating device 201 according to the second embodiment. In the flowchart of FIG. 19, first, the answer generating device 201 judges whether a question sentence (first question sentence) has been received (step S1901).

Here, the answer generating device 201 waits for the question sentence to be received (step S1901: NO). Then, in a case where the question sentence has been received (step S1901: YES), the answer generating device 201 proofreads the received question sentence using the language model M (step S1902).

Thereafter, the answer generating device 201 refers to the sentence features table 1400 to retrieve the sentence feature data related to the proofread question sentence (step S1903). Then, the answer generating device 201 uses the language model M according to the retrieved sentence feature data to generate a question sentence (second question sentence) in which a style of the proofread question is changed so as not to change the meaning from the proofread question sentence (step S1904).

Next, the answer generating device 201 calculates a sentence vector by vectorizing the generated question sentence (step S1905). Then, the answer generating device 201 retrieves related QAs that have similar characteristics to the generated question sentence from sentence database 220, based on the calculated sentence vector (step S1906).

Following that, the answer generating device 201 generates an answer to the received question using the language model M based on the retrieved related QAs and the generated question sentence (step S1907). Then, the answer generating device 201 outputs the generated answer in association with the received question sentence (step S1908) and ends a series of processes according to this flowchart.

As described, the answer generating device 201 can output an answer to the received question.

As described above, the answer generating device 201 according to the second embodiment can retrieve the first sentence data related to the proofread first question sentence by referring to the storage unit 510 that stores a plurality of sentence data. Here, the plurality of sentence data sentence data includes a sentence data representing a correspondence relationship with a style used in a sentence represented by at least any of the sentence data included in the plurality of sentence data and a different style that is synonymous with the style. Then, according to the answer generating device 201, a second question sentence is generated in which the first style included in the proofread first question sentence is modified to a second style so as not to change the meaning of the second question sentences using the language model M.

Therefore, in generating an answer to a question sentence (first question sentence), the answer generating device 201 can improve the retrieval accuracy of information related to the question sentence (for example, related QA). For example, the answer generating device 201 can generate a question that is more likely to hit a more appropriate related QA by customizing the question sentence according to the technical terms and expressions often used in a specific field using the sentence feature table 1400. In retrieving the first sentence data, the answer generating device 201 may vectorize the proofread first question sentence and can reduce the processing load required for retrieving the first sentence data.

The sentence database 220 may include a sentence related to a plurality of fields. In this case, the answer generating device 201 may prepare the sentence feature table 1400 as depicted In FIG. 14 for each field included in the plurality of fields. Then, the answer generating device 201 may retrieve the first sentence data by referring to the sentence feature table 1400 for each field included in the plurality of fields.

Thus, the answer generating device 201 can customize the question sentence for each field included in the multiple fields according to the technical terms and phrases often used in each field, thereby generating a question sentence that is more likely to hit a more appropriate related QA.

When receiving the first question sentence, the answer generating device 201 may receive a designation of which field the question sentence is related to. In this case, the answer generating device 201 may, for example, retrieve the first sentence data by referring to the sentence feature table 1400 corresponding to the designated field.

The first and second embodiments may be combined within a range causing no contradiction. For example, the second retrieving unit 1501 of the answer generating device 201 according to the second embodiment may have the same function as the retrieving unit 503 of the answer generating device 201 according to the first embodiment. The second modifying unit 1502 of the answer generating device 201 according to the second embodiment may have the same function as the modifying unit 504 of the answer generating device 201 according to the first embodiment.

Thus, according to the answer generating device 201 of the present embodiment, the retrieval accuracy of information related to the question sentence can be improved, thereby allowing a highly accurate answer to the question sentence to be generated. For example, the answer generating device 201 can achieve a highly accurate and natural response even to a highly specialized question about a specific field (such as a company or public service).

Here, the score depicted in the following formula (1) is an evaluation index that indicates the retrieval accuracy of information related to a question sentence. The score corresponds to a composite calculation of the probability of the existence of “related QA: T1”, “possibly related QA: T2”, and “unrelated QA: T3” when a plurality of related QAs is selected for the question. However, which QAs are related QAs, possibly related QAs, and unrelated QAs are known. n1, n2, and n3 are “{n1, n2, n3}={2, 1, 2}”. Ideally, the probabilities p1 and p2 of T1 and T2 are 100%. The probability p3 of T3 is 0%.

$$Score = \frac{{n}_{1} {p}_{1} + {n}_{2} {p}_{2} + {n}_{3} ( 2 - \frac{2}{1 + exp ( - 10 {p}_{3} )} )}{{n}_{1} + {n}_{2} + {n}_{3}} \qquad ( 1 )$$

Taking this score as an example, by applying this generation method, as a result, the retrieval accuracy was improved by about 4.4% compared to a case where this generation method is not applied.

The generation method described in the embodiments can be implemented by executing a prepared program on a computer such as a personal computer and a workstation. This generation program is recorded on a non-transitory, computer-readable recording medium such as a hard disk, flexible disk, CD-ROM, DVD, and USB memory to be executed by being read from the recording medium by the computer. This generation program may be distributed via a network such as the Internet.

The information processing device 101 (answer generating device 201) described in the embodiments can also be implemented by an application specific IC such as a standard cell and a structured application specific integrated circuit (ASIC) or a programmable logic device (PLD) such as an FPGA.

According to one aspect of the present invention, an effect of improving retrieval accuracy of information related to a question sentence is achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein a generation program for causing a computer to execute a process comprising:
retrieving a first sentence data related to a first question sentence by referring to a storage unit that stores a plurality of sentence data; and
generating a second question sentence in which a style of the first question sentence is modified so as to maintain a meaning of the first question sentence, the second question sentence being generated based on the retrieved first sentence data, using a first language model for generating a sentence.

2. The computer-readable recording medium according to claim 1, the process further comprising
proofreading the first question sentence using a second language model that is a same as or different from the first language model, wherein
the retrieving includes retrieving the first sentence data related to the proofread first question sentence by referring to the storage unit, and
the generating includes generating the second question sentence in which a style of the proofread first question sentence is modified so as to maintain the meaning of the proofread first question sentence.

3. The computer-readable recording medium according to claim 1, the process further comprising:
retrieving a second sentence data related to the generated second question sentence by referring to the storage unit; and
generating, based on the retrieved second sentence data and the second question sentence, an answer to the first question sentence using a third language model that is a same as or different from the first language model.

4. The computer-readable recording medium according to claim 1, wherein
the plurality of sentence data includes a sentence data representing a sentence and a feature amount of the sentence, and
the retrieving the first sentence data includes referring to the storage unit to compare the feature amount of the sentence represented by the sentence data included in the plurality of sentence data with a feature amount of the first question sentence and thereby retrieve the first sentence data representing a sentence with a feature similar to the first question sentence.

5. The computer-readable recording medium according to claim 3, wherein
the plurality of sentence data includes a sentence data representing a sentence and a feature amount of the sentence, and
the retrieving the second sentence data includes referring to the storage unit to compare the feature amount of the sentence represented by the sentence data included in the plurality of sentence data with a feature amount of the second question sentence and thereby retrieve the second sentence data representing a sentence with a feature similar to the second question sentence.

6. The computer-readable recording medium according to claim 1, wherein
the plurality of sentence data includes a sentence data representing a correspondence relationship between a style used in a sentence represented by at least any one of the plurality of sentence data and a different style synonymous with the style,
the retrieving the first sentence data includes referring to the storage unit to retrieve the first sentence data representing a correspondence relationship between a first style included in the first question sentence and a second style synonymous with the first style and used in the sentence represented by the at least any one of the plurality of sentence data, and
the generating the second question sentence includes generating the second question sentence in which the first style included in the first question sentence is modified into the second style so as to maintain the meaning of the first question sentence.

7. The computer-readable recording medium according to claim 6, wherein
the sentence represented by the at least any one of the plurality of sentence data is related to a specific field.

8. The computer-readable recording medium according to claim 1, wherein
the generating the second question sentence includes:
creating a prompt instructing a rewriting of the first question sentence using, as much as possible, a style used in a sentence represented by the first sentence data so as to maintain the meaning of the first question sentence; and
generating the second question sentence by providing the created prompt to the first language model.

9. The computer-readable recording medium according to claim 3, further comprising
associating and outputting the generated answer and the first question sentence.

10. The computer-readable recording medium according to claim 1, wherein
the first language model is a large language model (LLM).

11. A generation method executed by a computer, the generation method comprising:
retrieving a first sentence data related to a first question sentence by referring to a storage unit that stores a plurality of sentence data; and
generating a second question sentence in which a style of the first question sentence is modified so as to maintain a meaning of the first question sentence, the second question sentence being generated based on the retrieved first sentence data, using a first language model for generating a sentence.

12. An information processing device, comprising:
a memory; and
a processor coupled to the memory, the processor configured to:
retrieve a first sentence data related to a first question sentence by referring to a storage unit that stores a plurality of sentence data; and
generate a second question sentence in which a style of the first question sentence is modified so as to maintain a meaning of the first question sentence, the second question sentence being generated based on the retrieved first sentence data, using a first language model for generating a sentence.
